(19) United States
(12) Patent Application Publication
(10) Pub. No.: US 2020/0134754 A1
(43) Pub. Date: Apr. 30, 2020

(54) SYSTEM AND METHOD FOR DETERMINING A VALUE OF PROPERTY REFURBISHMENTS TO A PROPERTY SALE PRICE

(71) Applicant: Stoa Fund Ltd., Tel Aviv (IL)

(72) Inventors: Or AGASSI, Tel Aviv (IL); Tom SELLA, Miami, FL (US); Jonathan SARAGOSSI, Tel Aviv (IL)

(73) Assignee: Stoa Fund Ltd., Tel Aviv (IL)

(21) Appl. No.: 16/668,868

(22) Filed: Oct. 30, 2019

Related U.S. Application Data
(60) Provisional application No. 62/752,536, filed on Oct. 30, 2018.

(51) Int. Cl. G06Q 50/16; G06Q 30/02

(52) U.S. Cl. CPC G06Q 50/163; G06Q 30/0283

(57) ABSTRACT

A system and method for determining a value of property refurbishments to a property sale price, including: receiving a first dataset of descriptive information associated with a first property; receiving a second dataset including information related to one or more objectives made to the first property throughout a first refurbishment process; receiving a sale price of the first property after the refurbishment process is completed; searching for a second property in which at least one of the one or more objectives was made; collecting a third dataset associated with the at least a second property, wherein the third dataset comprises descriptive information of the at least a second property; analyzing the first dataset and the second dataset with respect to the third dataset; and, determining, based on the analysis, a value contribution for each of the plurality of objectives to the sale price of the first property.

### CROSS-REFERENCE TO RELATED APPLICATIONS

This application claims the benefit of U.S. Provisional Application No. 62/752,536 filed on Oct. 30, 2018, the contents of which are hereby incorporated by reference.

### TECHNICAL FIELD

The present disclosure relates generally to real-estate assessment tools, and more specifically to a system and method for determining a value of objectives performed throughout a property refurbishment process to a property sale price.

### BACKGROUND

Even though advances in technology have become available in most industrial areas, the real-estate domain remains dependent on extensive use of manual labor to perform tedious and costly tasks.

Refurbishment companies purchase properties with the goal of reselling them for a profit after the refurbishment costs. Profit is generated through price appreciation that occurs as a result of an increase of interest in the housing market, demographic trends and from developments and capital improvements to the property. However, refurbishment companies who employ these strategies face the risk of price depreciation in worsening housing markets.

Even in a solid housing market, refurbishment companies who expect to generate a relatively high return on properties purchased may encounter cash-flow difficulties due to the nature of such strategies. Therefore, one of the most important issues for such a project is determining an accurate projection of the contribution of each objective that is made throughout the refurbishment process of the property. The objectives may include, for example, rehabilitation, renovation, replacement, demolition, cleaning, and the like. As an example scenario, a first set of objectives costing $5,000 made throughout a refurbishment process of a property may contribute $10,000 to the property sale price, while a second set of objectives costing $3,000 may contribute $17,000 to the property sale price.

It would be therefore advantageous to provide a solution that overcomes the deficiencies of the prior art by automatically determining a value contribution of objectives performed throughout a property refurbishment process to the property sale price.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for determining a value of property refurbishments to a property sale price, including: receiving a first dataset associated with a first property, wherein the first dataset comprises descriptive information about the first property; receiving a second dataset associated with the first property, wherein the second dataset comprises information related to one or more objectives made to the first property throughout a first refurbishment process; receiving a sale price of the first property after the refurbishment process is completed; searching for at least a second property in which at least one of the one or more objectives was made to a second refurbishment process; collecting a third dataset associated with the at least a second property, wherein the third dataset comprises descriptive information of the at least a second property; analyzing the first dataset and the second dataset with respect to the third dataset, wherein the analysis includes measuring multiple parameters of a refurbishment; and, determining, based on the analysis, a value contribution for each of the plurality of objectives to the sale price of the first property.

Certain embodiments disclosed herein also include a non-transitory computer readable medium having stored thereon instructions for causing a processing circuitry to perform a process, the process including: receiving a first dataset associated with a first property, wherein the first dataset comprises descriptive information about the first property; receiving a second dataset associated with a first property, wherein the second dataset comprises information related to one or more objectives made to the first property throughout a first refurbishment process; receiving a sale price of the first property after the refurbishment process is completed; searching for at least a second property in which at least one of the one or more objectives was made to a second refurbishment process; collecting a third dataset associated with the at least a second property, wherein the third dataset comprises descriptive information of the at least a second property; analyzing the first dataset and the second dataset with respect to the third dataset, wherein the analysis includes measuring multiple parameters of a refurbishment; and, determining, based on the analysis, a value contribution for each of the plurality of objectives to the sale price of the first property.

Certain embodiments disclosed herein also include a system for determining a value of property refurbishments to a property sale price, including: a processing circuitry; and a memory, the memory containing instructions that, when executed by the processing circuitry, configure the system to: receive a first dataset associated with a first property, wherein the first dataset comprises descriptive information about the first property; receive a second dataset associated with a first property, wherein the second dataset comprises information related to one or more objectives made to the first property throughout a first refurbishment process; receive a sale price of the first property after the refurbishment process is completed; search for at least a second property in which at least one of the one or more objectives was made to a second refurbishment process; collect a third dataset associated with the at least a second property, wherein the third dataset comprises descriptive information of the at least a second property; analyze the first dataset and the second dataset with respect to the third dataset, wherein the analysis includes measuring multiple parameters of a refurbishment; and, determine, based on the analysis, a value contribution for each of the plurality of objectives to the sale price of the first property.

Certain embodiments disclosed herein also include a method of predicting a projected value contribution of at least one objective to a projected sale price of a property, including: receiving a request to determine the projected value contribution of at least one objective to a projected sale price of a first property; receiving a first dataset associated with the first property, wherein the first dataset comprises descriptive information about the first property; searching for at least a second property in which the at least one objective was performed throughout a second refurbishment process; collecting a second dataset that is associated with the at least a second property, wherein the second dataset comprises information related to one or more objectives made to the second property throughout a refurbishment process; determining, based on an analysis of the second dataset, an average value contribution of the at least one objective to a second property sale price; and, determining the projected value contribution of the at least one objective to the projected sale price of the first property based on the determination of the average value contribution of the at least one objective to the at least a second property sale price.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is network diagram of a system utilized to describe the various embodiments disclosed herein according to an embodiment.

FIG. 2 is a block diagram of a server according to an embodiment.

FIG. 3 is an example flowchart illustrating a method for determining a value contribution to the property sale price of objectives performed throughout a property refurbishment process according to an embodiment.

FIG. 4 is an example flowchart illustrating a method for predicting a projected value contribution of an objective to a projected sale price of a property according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

Disclosed is a method for determining the contribution of objectives performed throughout a property refurbishment process to the property sale price. After collecting and analyzing data that indicates a first property purchase price, objectives made to the first property throughout a refurbishment process, and a sale price of the first property after the refurbishment process is completed, a search is performed for a second property in which similar or identical objectives were made with respect to the first property. The search results may include the second property purchase price, the objectives made in the second property, the second property location, and the second property sale price. The data associated with the first property and with the second property is then analyzed such that a value contribution of each of the plurality of objectives to the sale price of the first property is determined.

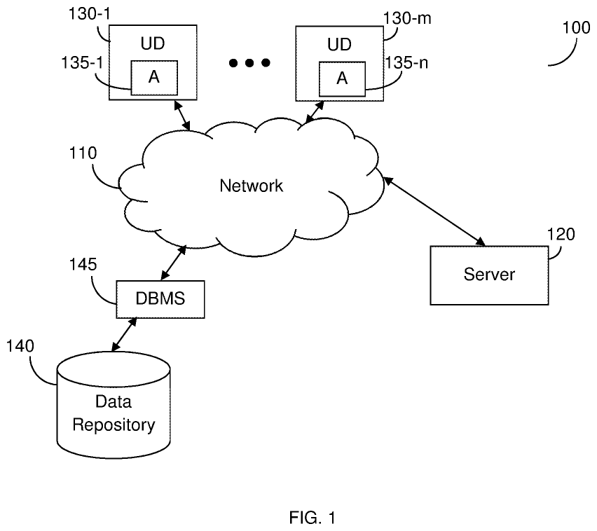

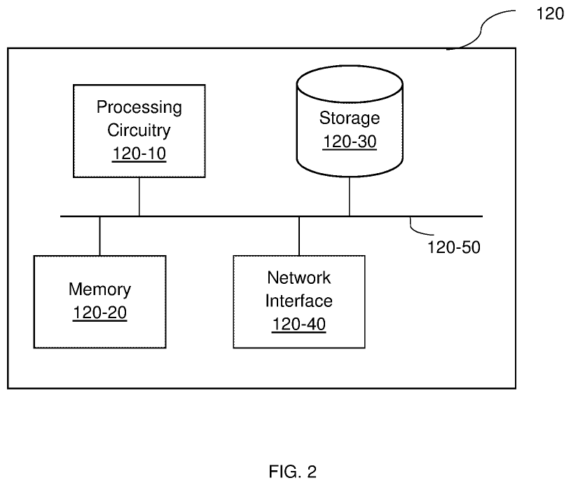

FIG. 1 is a network diagram of a system 100 for determining a value contribution of objectives performed through a property refurbishment process to a property sale price according to an embodiment. A server 120 is connected to a network 110. The server 120 and its components are described below in more detail with respect of FIG. 2. The network 110 is used to communicate between different parts of the system 100 and my include the Internet, the world-wide-web (WWW), a local area network (LAN), a wide area network (WAN), a metro area network (MAN), and other networks capable of enabling communication between the elements of the system 100.

Optionally, one or more user devices 130-1 through user device 130-m, referred to individually as user device 130 and collectively as user devices 130, where m is an integer equal to or greater than 1, may be connected to the server 120 through the network 110.

A user device 130 may be, e.g., a smart phone, a mobile phone, a laptop, a tablet computer, a wearable server, a personal computer (PC), a smart television and other kinds of wired and mobile appliances equipped with browsing, viewing, capturing, storing, listening, filtering, and managing capabilities enabled as further discussed herein below.

The user device 130 may be configured to send to and receive from the server 120 data, metadata, datasets, and the like that relates to, e.g., a first property, at least a second property, a purchase price, a sale price, characteristics of objectives made throughout a refurbishment of each property, and so on. Each user device 130 may further include a software application (App) 135 installed thereon. An App 135 may be downloaded from an application repository, such as Apple® AppStore®, Google® Play®, or any repositories hosting software applications. The application 135 may be pre-installed in the user device 130. In one embodiment, the application 135 is a web-browser.

It should be noted that only one user device 130 and one application 135 are discussed herein merely for the sake of simplicity. However, the embodiments disclosed herein are applicable to a plurality of user devices that can communicate with the server 120 through the network 110.

A data repository 140, referred to individually as data repository 140 and collectively as data repositories 140, may be connected to the server 120 through the network 110, or embedded within the server 120 (not shown). The data repository 140 may be connected to the network 110 through a database management service (DBMS) 145, which is a system software for creating and managing databases. The data repository 140 may be for example, a storage device containing a database, a data warehouse, and the like. The data repository 140 may be used to store datasets, data, metadata, and the like, associated with various property purchase prices, property sale prices, metadata associated with properties, datasets associated with objectives made throughout a refurbishment processes of properties such as the objectives cost, timeline of objective completion, increase of value associated with the objectives, and so on.

In an embodiment, the server 120 receives a first dataset that is associated with a first property. The first property may be for example a house, an apartment, and so on. The first dataset may include at least a purchase price of the first property and a location of the first property, images and videos of the first property, and so on. The first dataset may be received from a user device, e.g., the user device 130. In a further embodiment, the first dataset may be collected from a database such as the data repository 140. For example, the first dataset may indicate that the property is a house located at NW 38th Street, Miami, Fla., US, that was purchased for $60,000.

In an embodiment, the server 120 obtains a second dataset that includes information related to one or more objectives made in the first property throughout a refurbishment process. The objectives made throughout the refurbishment process may include, for example and without limitations, rehabilitation, renovation, replacement, demolition, cleaning, painting, installation of new appliances, and the like. The second dataset may include a first set of metadata related to the one or more objectives. The first set of metadata may indicate the cost of each of the one or more objectives, where each product or service associated with the one or more objectives was purchased, e.g., from which vendor, and the like. As a non-limiting example, the second dataset may indicate that throughout the refurbishment of the first property, two objectives have been performed, where the first objective is the cleaning of the whole property, and the second objective is painting only the living room. According to the same example, the second dataset also includes metadata that indicates the costs associated with cleaning the property and painting only the living room.

In an embodiment, the server 120 receives a sale price of the first property after the refurbishment process is completed. The sale price may be received from the user device 130. In an embodiment, the sale price may be retrieved from one or more web sources (not shown). These web sources may include real estate databases and governmental record databases. It should be noted that the sale price is affected by the objectives performed in the first property throughout the refurbishment process.

In an embodiment, the server 120 searches for at least a second property in which at least one of the objectives was performed throughout a second refurbishment process performed on the second property. The second property may be for example a house, an apartment, and the like. The objectives that were made to both the first property and the second property may include rehabilitation, renovation, replacement, demolition, cleaning, painting, installation of new appliances, and the like. Thus, the server 120 is configured to identify multiple properties that were previously refurbished with one or more of the same objectives used throughout the first refurbishment process of the first property. In an embodiment, the search results includes 30 properties that were refurbished using at least one similar objective, including more specific details such as, using an identical color for painting the property, installing parquet floor in the living room, installing a particular faucet in the bathroom, and the like.

In an embodiment, the server 120 collects a third dataset that is associated with at least the second property. The third dataset may include a purchase price of the second property, a sale price of the second property, a location of the second property, a second set of metadata that is related to the one or more objectives that were made throughout the refurbishment of the second property. As a non-limiting example, the third dataset may refer to 10,000 second properties that were previously refurbished using at least one of the objectives that were performed throughout the first property refurbishment. According to the same example, the third dataset indicates that 4,000 out of 10,000 properties are located in Orlando, Fla.; that 3,000 properties are located in Houston Tex.; and that 3,000 are located in Miami, Fla. According to the same example, the third dataset further includes the metadata associated with the objectives that were performed throughout the refurbishment of the 10,000 properties, such as the cost and vendor for each objective. According to the same example, the third dataset further includes the sale price of all the 10,000 second properties after the refurbishments were completed, and the difference between the sale price post refurbishment and the purchase price prior to refurbishment.

In an embodiment, the server 120 analyzes the first dataset and the second dataset with the third dataset. The analysis may be achieved using at least one machine learning model that is configured to compute, using one or more algorithms, the contribution of one or more objectives performed throughout refurbishment processes of multiple properties, to the sale price of the properties. In an embodiment, the machine learning model includes various machine learning techniques, e.g., deep learning, neural networks, such as deep convolutional neural network, recurrent neural networks, decision tree learning, Bayesian networks, clustering, and the like. The analysis may further be achieved using one or more statistical techniques to determine the contribution of each objective made to the sale price of the properties, and especially to the first property.

In an embodiment, the server 120 may be configured to determine, based on the analysis, a value contribution for each of the one or more objectives to the sale price of the first property. The value contribution of each of the one or more objectives may be represented by, for example, a percentage of the sale price of the property, a dollar amount, and the like. As a non-limiting example, the analysis results may indicate that when the property is located in Miami, Fla., the return on investment (ROI) for cleaning the property will be $5,000 while the ROI for cleaning a similar property in Chicago will be $2,500. As a further non-limiting example, the analysis results may indicate that installing a hard wood floor contributes an increase of an average of 5% to the property sale price. The determination of the value contribution of each of the one or more objectives made to the first property is extracted from multiple comparable second properties within the third database sharing at least one similar objective, where the comparable property and similar objective match the first property and an objective, respectively, above a predetermined threshold. In a further embodiment, the value contribution of each of the one or more objectives is stored in a database, e.g. the data repository 140.

FIG. 2 shows a block diagram of a server 120 for determining a value contribution of objectives performed throughout a property refurbishment process to the property sale price according to an embodiment. The server 120 includes at least one processing circuitry 120-10, for example, a central processing unit (CPU). In an embodiment, the processing unit 120-10 includes, or is a component of, a larger processing unit implemented with one or more processors. The processing circuitry 120-10 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), graphics processing units (GPUs), general-purpose microprocessors, microcontrollers, digital signal processors (DSPs), and the like, or any other hardware logic components that can perform calculations or other manipulations of information. The processing circuitry 120-10 is coupled via a bus 120-50 to a memory 120-20.

The memory 120-20 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 120-10 to perform the various processes described herein.

The memory 120-20 may be further used as a working scratch pad for the processing circuitry 120-10, a temporary storage, and others, as the case may be. The memory 120-20 may be a volatile memory such as, but not limited to random access memory (RAM), or non-volatile memory (NVM), such as, but not limited to, flash memory.

The processing circuitry 120-10 may be coupled to a network device 120-40, such as a network interface card, for providing connectivity between the server 120 and a network, such as the network 110 discussed in more detail with respect to FIG. 1. The processing circuitry 120-10 may be further coupled with a storage 120-30. The storage 120-30 may be used for the purpose of storing properties purchase price, properties sale price, metadata associated with properties, datasets associated with objectives made throughout a refurbishment processes of properties such as the objectives cost, and so on.

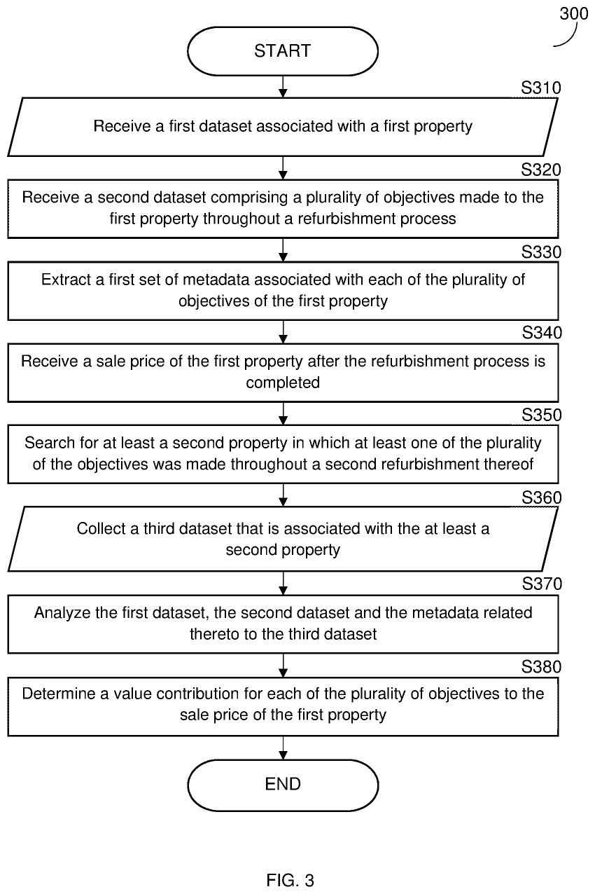

FIG. 3 is an example flowchart 300 describing a method for determining a value contribution to the property sale price of objectives performed throughout a property refurbishment process according to an embodiment. In an embodiment, the method described herein below may be executed using the server 120 that is further discussed with respect of FIG. 2.

At S310, a first dataset that is associated with a first property is received. The first dataset includes descriptive information about the first property, such as a purchase price of the first property, a location of the first property, images and videos of the first property, and the like.

At S320, a second dataset that includes information related to one or more objectives made to the first property throughout the refurbishment process is obtained. Objectives include improvements to the property, such as rehabilitation, renovation, replacement, demolition, cleaning, painting, installation of new appliances, and the like.

At S330, a first set of metadata associated with each of the one or more objectives is extracted from the second dataset. The first set of metadata may include a cost of each of the one or more objectives, a vendor providing the service or goods associated with the objectives, a time period for completing the objectives, and the like.

At S340, a sale price of the first property after the refurbishment process is completed is received.

At S350, a search is performed for at least a second property in which at least one of the one or more the objectives was made throughout a second refurbishment thereof.

At S360, a third dataset associated with the at least a second property is collected. The third dataset comprises descriptive information of the at least a second property, which may include a sale price of the at least a second property, a location of the at least a second property and a second set of metadata that is related to the one or more objectives that was made throughout the refurbishment of the at least a second property.

At S370, the first dataset, the second dataset and the metadata related thereto are analyzed with respect to the third dataset. The analysis may be achieved using at least one machine learning model that is configured to calculate, using one or more algorithms, the contribution of one or more objectives performed throughout refurbishment processes of multiple properties, to the sale price of the properties. The analysis may further be achieved using one or more statistics techniques to determine the contribution of each objective made to the sale price of the properties, and especially the first property. The analysis includes measuring multiple parameters of a refurbishment, such as time taken for each part of the refurbishment, values of environmental variables, such as the neighborhood of the property, the economic trends within the area, images of the completed objectives, and the like.

At S380, a value contribution for each of the one or more objectives to the sale price of the first property is determined based on the analysis.

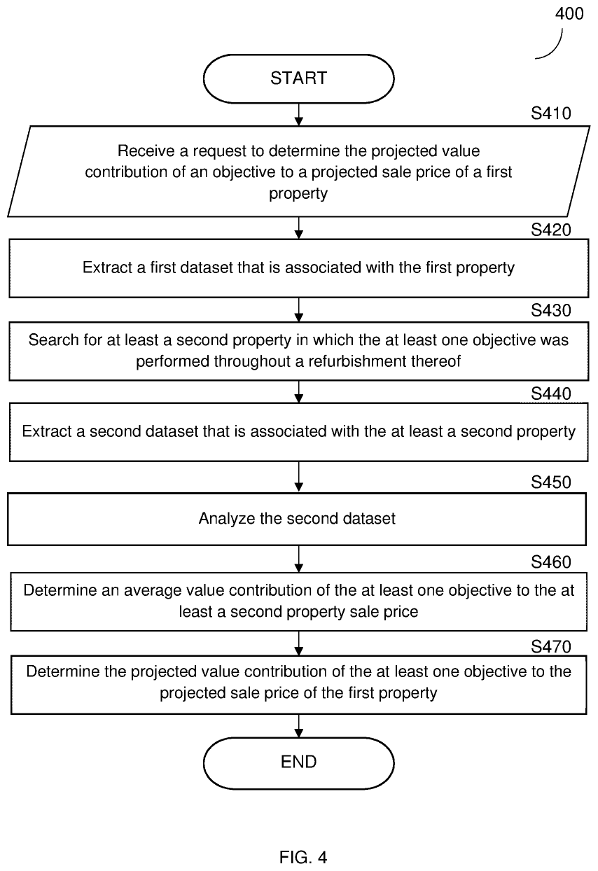

FIG. 4 is an example flowchart 400 describing a method for predicting a projected value contribution of at least one objective to a projected sale price of a property according to an embodiment. In an embodiment the method described herein below may be executed using the server 120 that is further discussed with respect of FIG. 2.

At S410, a request to determine the projected value contribution of at least one objective to a projected sale price of a first property is received. The request may be received from a user device, e.g. the user device 130. The at least one objective may be for example, rehabilitation, renovation, replacement, demolition, cleaning, painting, etc. As a non-limiting example, the request may indicate that the value contribution of cleaning the property is needed. According to another embodiment the projected value contribution of multiple objectives may be determined simultaneously.

At S420, a first dataset associated with the first property is extracted. The first dataset may include at least a purchase price of the first property, a location of the first property, images and video of the property, environmental parameters, and so on. The first property may be for example, a house, an apartment, and so on.

At S430, a search is performed for at least a second property in which the at least one objective was performed throughout a refurbishment thereof. The second property may be for example, a house, an apartment, and so on. that was previously refurbished using the at least one objective. For example, if the projected value contribution of painting the property in green is requested, the server 120 may search and identify 50 properties that were painted in green throughout the properties' refurbishment.

At S440, a second dataset associated with the at least a second property is extracted. The second dataset may include a purchase price of the second property, a sale price, a location of the second property, a set of metadata that is related to the at least one objective that was performed throughout the refurbishment of the at least a second property.

At S450, the second dataset is analyzed. The analysis may include computing using statistical techniques a plurality of parameters of the second dataset and generating analytics respective thereof.

At S460, an average value contribution of the at least one objective to the at least a second property sale price is determined.

At S470, the projected value contribution of the at least one objective to the projected sale price of the first property is determined based on the determination of the average value contribution of the at least one objective to the at least a second property sale price.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for determining a value of property refurbishments to a property sale price, comprising:
receiving a first dataset associated with a first property, wherein the first dataset comprises descriptive information about the first property;
receiving a second dataset associated with the first property, wherein the second dataset comprises information related to one or more objectives made to the first property throughout a first refurbishment process;
receiving a sale price of the first property after the refurbishment process is completed;
searching for at least a second property in which at least one of the one or more objectives was made to a second refurbishment process;
collecting a third dataset associated with the at least a second property, wherein the third dataset comprises descriptive information of the at least a second property;
analyzing the first dataset and the second dataset with respect to the third dataset, wherein the analysis includes measuring multiple parameters of a refurbishment; and,
determining, based on the analysis, a value contribution for each of the plurality of objectives to the sale price of the first property.

2. The method of claim 1, wherein the first dataset comprises at least a purchase price of the first property and a location of the first property.

3. The method of claim 1, wherein the second dataset comprises a first set of metadata associated with each of the plurality of objectives, wherein the first set of metadata comprises at least a cost of each of the plurality of objectives.

4. The method of claim 1, wherein the one or more objectives includes at least one of: rehabilitation, renovation, replacement, demolition, cleaning, painting, and installation of new appliances.

5. The method of claim 1, wherein the third dataset comprises at least a sale price of the at least a second property, a location of the at least a second property and a second set of metadata that is related to the one or more objectives that was made throughout the second refurbishment process.

6. The method of claim 1, further comprising:
storing the value contribution of each of the plurality of objectives in a database.

7. The method of claim 1, wherein the analysis is achieved using at least one machine learning model configured to calculate the contribution of the one or more objectives performed throughout the second refurbishment processes to the sale price of the second property.

8. The method of claim 7, wherein the machine learning model includes at least one of: deep learning, neural networks, such as deep convolutional neural network, recurrent neural networks, decision tree learning, Bayesian networks, and clustering.

9. The method of claim 1, wherein the determination of the value contribution of the one or more objectives made to the first property is extracted from multiple comparable second properties within the third database sharing at least one similar objective, where the comparable property and similar objective match the first property and an objective, respectively, above a predetermined threshold.

10. A non-transitory computer readable medium having stored thereon instructions for causing a processing circuitry to perform a process, the process comprising:
receiving a first dataset associated with a first property, wherein the first dataset comprises descriptive information about the first property;
receiving a second dataset associated with a first property, wherein the second dataset comprises information related to one or more objectives made to the first property throughout a first refurbishment process;
receiving a sale price of the first property after the refurbishment process is completed;
searching for at least a second property in which at least one of the one or more objectives was made to a second refurbishment process;
collecting a third dataset associated with the at least a second property, wherein the third dataset comprises descriptive information of the at least a second property;
analyzing the first dataset and the second dataset with respect to the third dataset, wherein the analysis includes measuring multiple parameters of a refurbishment; and,
determining, based on the analysis, a value contribution for each of the plurality of objectives to the sale price of the first property.

11. A system for determining a value of property refurbishments to a property sale price, comprising:
a processing circuitry; and
a memory, the memory containing instructions that, when executed by the processing circuitry, configure the system to:
receive a first dataset associated with a first property, wherein the first dataset comprises descriptive information about the first property;
receive a second dataset associated with a first property, wherein the second dataset comprises information related to one or more objectives made to the first property throughout a first refurbishment process;
receive a sale price of the first property after the refurbishment process is completed;
search for at least a second property in which at least one of the one or more objectives was made to a second refurbishment process;
collect a third dataset associated with the at least a second property, wherein the third dataset comprises descriptive information of the at least a second property;
analyze the first dataset and the second dataset with respect to the third dataset, wherein the analysis includes measuring multiple parameters of a refurbishment; and,
determine, based on the analysis, a value contribution for each of the plurality of objectives to the sale price of the first property.

12. A method of predicting a projected value contribution of at least one objective to a projected sale price of a property, comprising:
receiving a request to determine the projected value contribution of at least one objective to a projected sale price of a first property;
receiving a first dataset associated with the first property, wherein the first dataset comprises descriptive information about the first property;
searching for at least a second property in which the at least one objective was performed throughout a second refurbishment process;
collecting a second dataset that is associated with the at least a second property, wherein the second dataset comprises information related to one or more objectives made to the second property throughout a refurbishment process;
determining, based on an analysis of the second dataset, an average value contribution of the at least one objective to a second property sale price; and,
determining the projected value contribution of the at least one objective to the projected sale price of the first property based on the determination of the average value contribution of the at least one objective to the at least a second property sale price.

13. The method of claim 12, wherein the first dataset comprises at least a purchase price of the first property and a location of the first property.

14. The method of claim 12, wherein the second dataset comprises at least a purchase price of the at least a second property, a sale price, a location of the at least a second property and a set of metadata that is related to the at least one objective that was performed throughout the refurbishment of the at least a second property.

15. A non-transitory computer readable medium having stored thereon instructions for causing a processing circuitry to perform a process, the process comprising:
receiving a request to determine the projected value contribution of at least one objective to a projected sale price of a first property;
receiving a first dataset associated with the first property, wherein the first dataset comprises descriptive information about the first property;
searching for at least a second property in which the at least one objective was performed throughout a second refurbishment process;
collecting a second dataset that is associated with the at least a second property, wherein the second dataset comprises information related to one or more objectives made to the second property throughout a refurbishment process;
determining, based on an analysis of the second dataset, an average value contribution of the at least one objective to a second property sale price; and,
determining the projected value contribution of the at least one objective to the projected sale price of the first property based on the determination of the average value contribution of the at least one objective to the at least a second property sale price.

16. A system for predicting a projected value contribution of at least one objective to a projected sale price of a property, comprising:
a processing circuitry; and
a memory, the memory containing instructions that, when executed by the processing circuitry, configure the system to:
receive a request to determine the projected value contribution of at least one objective to a projected sale price of a first property;
receive a first dataset associated with the first property, wherein the first dataset comprises descriptive information about the first property;
search for at least a second property in which the at least one objective was performed throughout a second refurbishment process;
collect a second dataset that is associated with the at least a second property, wherein the second dataset comprises information related to one or more objectives made to the second property throughout a refurbishment process;
determine, based on an analysis of the second dataset, an average value contribution of the at least one objective to a second property sale price; and,
determine the projected value contribution of the at least one objective to the projected sale price of the first property based on the determination of the average value contribution of the at least one objective to the at least a second property sale price.
